(19) United States
(12) Patent Application Publication
(10) Pub. No.: US 2008/0251508 A1
(43) Pub. Date: Oct. 16, 2008

(54) Electric fan/heater

(76) Inventor: Man-Yan Chan, Kowloon (CN)

Correspondence Address: ALIX YALE & RISTAS LLP, 750 MAIN STREET, SUITE 1400, HARTFORD, CT, 06103, US

(21) Appl. No.: 11/823,665

(22) Filed: Jun. 28, 2007

(30) Foreign Application Priority Data
Apr. 13, 2007 (HK) 07103873.9

(51) Int. Cl. H05B 1/00

(52) U.S. Cl. 219/209

(57) ABSTRACT

A fan/heater includes a body having a spherically shaped resting surface, an air inlet and an air outlet. The body houses a heating element and a fan causing a flow of air from the inlet to the outlet past the heating element. The fan/heater also includes a base having a bottom surface enabling the base to rest on a flat surface such as a floor, and a spherically shaped bearing surface complementing the shape of the body's resting surface and against which the resting surface frictionally bears to support the body on the base in any one of a multitude of desired angles.

### BACKGROUND OF THE INVENTION

The present invention relates to electric fans and fan heaters. More particularly, although not exclusively, the invention relates to an electric fan/heater capable of resting upon a flat surface and oriented at one of a multitude of desired angles.

Fans and fan heaters are of course known in which a forced stream of heated air is directed at a fixed, nonadjustable angle. In order to adjust the angle of the stream of heated air, the fan/heater itself must be moved. Other fan/heaters are known in which angular adjustment is facilitated by a single-axis pivoted base. The pivot axis might be either vertical or horizontal—providing a single degree of pivotal movement.

Such fans/heaters as described above are limited in their ability to exude a heated air stream at one of a multitude of desired set angles.

### OBJECTS OF THE INVENTION

It is an object of the present invention to overcome or substantially ameliorate at least one of the above disadvantages and/or more generally to provide an improved fan/heater.

### DISCLOSURE OF THE INVENTION

There is disclosed herein a fan/heater comprising:

a body having a substantially spherically shaped resting surface, an air inlet and an air outlet, the body housing a fan causing a flow of air from the inlet to the outlet, and

a base having a bottom surface enabling the base to rest on a flat surface, and a spherically shaped bearing surface complementing the shape of the body's resting surface and against which the resting surface bears to support the body on the base in any one of a multitude of desired angles.

Preferably, the fan/heater further comprises a heating element within the body and past which said flow of air is induced by the fan.

Preferably, the external surface of the body is substantially spherical in overall shape.

Preferably, the bearing surface of the base is an upwardly facing surface of the base.

Preferably, the bearing surface is substantially frusto-cylindrical.

Preferably, the heating element comprises a PTC ceramic stone.

Preferably, the fan comprises an impeller and a motor driving the impeller and situated between the PTC ceramic stone and the impeller.

Preferably, the fan/heater further comprises an air outlet grate of substantially spherical contour transitioning smoothly with the external surface of the body.

Preferably, the bearing surface and/or the resting surface interact with one another with a coefficient of static friction suitable for maintaining a fixed orientation of the body with respect to the base despite any vibration induced by the fan when the body rests on the base under normal use conditions.

### BRIEF DESCRIPTION OF THE DRAWINGS

A preferred form of the present invention will now be described by way of example with reference to the accompanying drawings, wherein:

FIG. 1 is a schematic parts-exploded perspective illustration of a fan heater body and base,

FIG. 2 is a schematic cross-sectional elevation of the fan heater of FIG. 1, and

FIG. 3 is a schematic perspective illustration of the fan heater of FIG. 2.

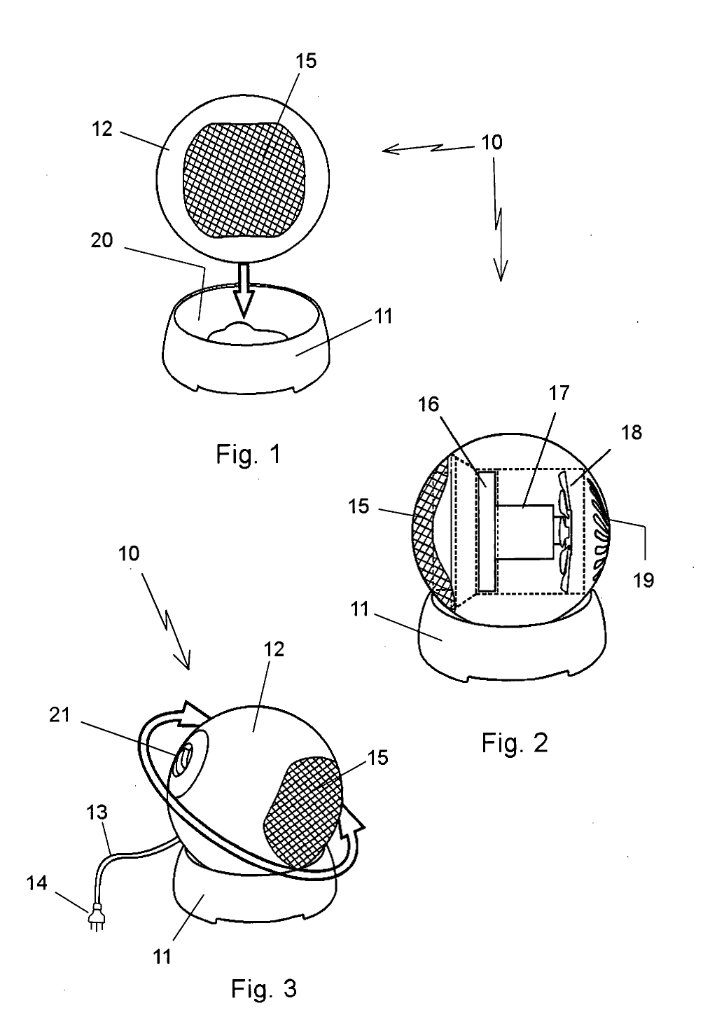

### DESCRIPTION OF THE PREFERRED EMBODIMENT

In the accompanying drawings there is depicted schematically a fan heater 10. The fan heater comprises a base 11 designed to sit upon a flat surface such as a floor. The base 11 is typically made of moulded plastics material and includes an upwardly facing bearing surface 20 of frusto-cylindrical concave shape.

The fan heater 10 also includes a body 12 of substantially spherical shape having a radius the same as that of the bearing surface 20. Accordingly, the body 12 includes a convex bottom surface which can rest upon the bearing surface 20 and can be oriented at many angles about its centre point.

The body 20 is typically formed of moulded plastics material and has an outlet grate 15 which could be of metallic material or other heat-resistant (and preferably low heat-capacitive) material. The grate 15 has a spherical contour that is smoothly continuous in profile with the outer surface of the body 12. Diametrically opposite the grate 15 is an air inlet 19.

Situated internally of the body 12 between the inlet 19 and grate 15 is an electric motor 17 which drives an impeller 18 to draw in air via the inlet 19. Between the motor 17 and the grate 15 is a heating element 16. The heating element 16 could comprise a conventional elongate resistance wire wrapped back and forth about a mica former for example. Preferably however, the heating element comprises a PTC (Positive Temperature Coefficient) ceramic stone that is available commercially.

The heating element 16 and electric motor 17 are controlled by a control switch and/or dial 21. Electric power is provided via a flexible cord 13 having a plug 14 for insertion to a mains wall outlet. The cord 13 extends directly from the body 12 and is not attached to the base 11.

In use, the body 12 is placed down upon the bearing surface 20 of base 11 and positioned so that the grate 15 is oriented as desired to point at a desired heated airflow target. This might be achieved by pivoting the body 12 about a horizontal axis that passes through the centre point of the body 12 and/or about a vertical axis that passes through the centre point of the body 12.

The bearing surface 20 and/or mating external surface of the body 12 can be smooth to enable easy pivoting of the body 12 when resting upon the base 11. Alternatively, the bearing surface 20 and/or the mating surface of the body 12 might be rough, textured or otherwise made frictional so that the body 12 can be lifted from the base 11 for reorientation purposes and once placed—remain in position against any vibrational forces which might be induced by motor 17, fan 18, or external sources of vibration.

It should be appreciated that modifications and alterations obvious to those skilled in the art are not to be considered as beyond the scope of the present invention. For example, the body 12 might be secured to the base 11 by means enabling pivotal orientation of the body with respect to the base as described. Also, the heating element might be omitted in the case where the appliance is to be sold as a fan only.

1. A fan/heater comprising:
a body having a substantially spherically shaped resting surface, an air inlet and an air outlet, the body housing a fan causing a flow of air from the inlet to the outlet, and
a base having a bottom surface enabling the base to rest on a flat surface, and a spherically shaped bearing surface complementing the shape of the body's resting surface and against which the resting surface bears to support the body on the base in any one of a multitude of desired angles.

2. The fan/heater of claim 1, further comprising a heating element within the body and past which said flow of air is induced by the fan.

3. The fan/heater of claim 1, wherein the external surface of the body is substantially spherical in overall shape.

4. The fan/heater of claim 1, wherein the bearing surface of the base is an upwardly facing surface of the base.

5. The fan/heater of claim 4, wherein the bearing surface is substantially frusto-cylindrical.

6. The fan/heater of claim 2, wherein the heating element comprises a PTC ceramic stone.

7. The fan/heater of claim 6, wherein the fan comprises an impeller and a motor driving the impeller and situated between the PTC ceramic stone and the impeller.

8. The fan/heater of claim 3, further comprising an air outlet grate of substantially spherical contour transitioning smoothly with the external surface of the body.

9. The fan/heater of claim 1, wherein the bearing surface and/or the resting surface interact with one another with a coefficient of static friction suitable for maintaining a fixed orientation of the body with respect to the base despite any vibration induced by the fan when the body rests on the base under normal use conditions.
